(19) United States
(12) Patent Application Publication
(10) Pub. No.: US 2024/0376312 A1
(43) Pub. Date: Nov. 14, 2024

(54) POLYAMIDE COMPOSITION

(71) Applicant: ASAHI KASEI KABUSHIKI KAISHA, Tokyo (JP)

(72) Inventors: Shogo OKUMURA, Tokyo (JP); Jun MIKAMI, Tokyo (JP); Shinji IEDA, Tokyo (JP); Ryosuke UMEMURA, Tokyo (JP); Takaaki MIYOSHI, Tokyo (JP)

(73) Assignee: ASAHI KASEI KABUSHIKI KAISHA, Tokyo (JP)

(21) Appl. No.: 18/686,987

(22) PCT Filed: Aug. 31, 2022
(86) PCT No.: PCT/JP2022/032767

§ 371 Date: Feb. 27, 2024

(30) Foreign Application Priority Data
Sep. 1, 2021 (JP) 2021-142318
Apr. 7, 2022 (JP) 2022-063916

(51) Int. Cl. C08L 77/10; C08K 3/04; C08K 5/20; C08K 5/3465; C08K 7/14

(52) U.S. Cl. CPC C08L 77/10; C08K 3/04; C08K 5/20; C08K 5/3465; C08K 7/14; C08K 2201/019; C08L 2201/08

(57) ABSTRACT

The present invention provides a polyamide composition containing a polyamide (A), and also containing, per 100 parts by mass of the polyamide (A), at least 0.1 parts by mass but not more than 3 parts by mass of a branched polyamine (B), at least 0.05 parts by mass but not more than 3 parts by mass of a sterically hindered phenol (C), and at least 0.01 parts by mass but not more than 0.5 parts by mass of an azine-based dye or phthalocyanine-based dye (D), wherein the concentration of halide ions (F) measured by combustion ion chromatography relative to the total mass of the polyamide composition is not more than 500 ppm by mass.

### TECHNICAL FIELD

The present invention relates to a polyamide composition.

### BACKGROUND ART

Polyamides exhibit excellent strength, heat resistance and chemical resistance, and also have excellent specific gravity. In other words, because their specific gravity is smaller than that of metals, they are conventionally widely used as metal substitute materials in mechanism components and the like for vehicles.

Among vehicle components are some that are exposed to high-temperature environments for long periods. In such cases, the material for the component requires sufficient thermal stability to maintain strength even when placed in a high-temperature environment for an extended period of time (hereinafter referred to as “long-term resistance to thermal aging”). Moreover, the move to vehicle electrification and the rise of EVs means there are now components having electronic contacts that are exposed to high-temperature environments (for example, environments of 180° C. or lower). The materials used for these types of components require long-term resistance to thermal aging at 180° C. as well as superior electrical characteristics (such as volume resistivity and tracking resistance).

Known examples of thermal stabilizers used in polyamides include copper halides used in combination with an alkali metal halide (for example, see Patent Document 1). However, although the addition of these thermal stabilizers produces a large effect in terms of thermal stabilization, the halide ions contained in these thermal stabilizers tend to cause a deterioration in the electrical resistivity and tracking resistance.

Because of these limitations, achieving a combination of long-term resistance to thermal aging at 180° C., high electrical resistivity and superior tracking resistance is difficult, and various research is still being actively pursued.

In light of the above circumstances, the development of a polyamide material that satisfies all the requirements of long-term resistance to thermal aging at 180° C., superior electrical characteristics and favorable external appearance would be very desirable.

One known technique for improving the long-term resistance to thermal aging without impairing the electrical characteristics of a polyamide is a method that uses an organic thermal stabilizer such as a sterically hindered phenol, an aromatic amine, or a sterically hindered amine. However, when this type of organic thermal stabilizer is used alone, the resistance to thermal aging at 180° C. remains unsatisfactory. Further, if the amount added of the organic thermal stabilizer is increased to improve the long-term resistance to thermal aging, then the additive tends to bleed out from the molded article, impairing the external appearance.

On the other hand, another known technique for improving the long-term resistance to thermal aging of a polyamide resin involves adding a polyethyleneimine to the polyamide as an effective thermal stabilizer (for example, see Patent Documents 2 and 3).

### CITATION LIST

### Patent Documents

### [Patent Document 1]

Japanese Unexamined Patent Application, First Publication No. Hei 08-325382

### [Patent Document 2]

Japanese Unexamined Patent Application, First Publication No. 2019-116607

### [Patent Document 3]

Japanese Translation of PCT International Application, Publication No. 2012-512301

### SUMMARY OF INVENTION

### Technical Problem

However, in Patent Documents 2 and 3, the only examples disclosed also require the addition of a copper halide. Halide ions cause a deterioration in the electrical characteristics. Further, in Patent Documents 2 and 3, there is no specific investigation of examples using an additive that absorbs a laser. In other words, a polyamide resin composition that exhibits excellent long-term resistance to thermal aging and superior electrical characteristics, has excellent external appearance, and displays good suppression of bleed out of the additive has yet to be developed.

The present invention has been developed in light of the above circumstances, and provides a polyamide composition that is capable of yielding a molded article that exhibits excellent mechanical properties, excellent resistance to thermal aging at 180° C. for long periods of about 2,000 hours and excellent electrical characteristics, suppresses the bleed out of additives at 80° C. and a relative humidity of 95%, resists elution of the additives into water, and also has excellent external appearance.

### Solution to Problem

In other words, the present invention includes the following aspects.

(1) A polyamide composition containing:
a polyamide (A),
and also containing, per 100 parts by mass of the polyamide (A):
at least 0.1 parts by mass but not more than 3 parts by mass of a branched polyamine (B),
at least 0.05 parts by mass but not more than 3 parts by mass of a sterically hindered phenol (C), and
at least 0.01 parts by mass but not more than 0.5 parts by mass of an azine-based dye or phthalocyanine-based dye (D), wherein
the concentration of halide ions (F) measured by combustion ion chromatography relative to the total mass of the polyamide composition is not more than 500 ppm by mass.

(2) The polyamide composition according to (1), wherein the polyamide (A) contains polyamide 66, and the amount of polyamide 66 relative to the total mass of the polyamide (A) is at least 50% by mass.

(3) The polyamide composition according to (1) or (2), wherein the branched polyamine (B) is a polyethyleneimine homopolymer or copolymer (Ba).

(4) The polyamide composition according to any one of (1) to (3), wherein the weight average molecular weight of the branched polyamine (B) is at least 400 but not more than 2,000.

(5) The polyamide composition according to any one of (1) to (4), wherein the sterically hindered phenol (C) contains at least one amide group.

(6) The polyamide composition according to any one of (1) to (5), also containing at least 0.01 parts by mass but not more than 0.5 parts by mass of a carbon black (E) per 100 parts by mass of the polyamide (A).

(7) The polyamide composition according to any one of (1) to (6), wherein the concentration of halide ions (F) measured by combustion ion chromatography relative to the mass of the azine-based dye or phthalocyanine-based dye (D) is less than 1% by mass.

(8) The polyamide composition according to any one of (1) to (7), wherein the weight ratio between the branched polyamine (B) and the sterically hindered phenol (C) is within a range from 0.06 to 30, and the weight ratio between the sterically hindered phenol (C) and the azine-based dye or phthalocyanine-based dye (D) is within a range from 0.5 to 60.

(9) The polyamide composition according to any one of (1) to (8), also containing a filler (G).

(10) A polyamide composition containing a polyamide (A), and
at least 0.1 parts by mass but not more than 3 parts by mass of a branched polyamine (B) per 100 parts by mass of the polyamide (A), wherein
the viscosity of the branched polyamine (B) at 20° C. measured using a Brookfield viscometer in accordance with ISO 2555 is at least 1,000 mPa·s but not more than 2,500 mPa·s.

(11) The polyamide composition according to (10), wherein the polyamide (A) contains polyamide 66, and the amount of polyamide 66 relative to the total mass of the polyamide (A) is at least 50% by mass.

(12) The polyamide composition according to (10) or (11), wherein the branched polyamine (B) is a polyethyleneimine homopolymer or copolymer (Ba).

(13) The polyamide composition according to any one of (10) to (12), wherein the weight average molecular weight of the branched polyamine (B) is at least 400 but not more than 2,000.

(14) The polyamide composition according to any one of (10) to (13), also containing at least 0.05 parts by mass but not more than 3 parts by mass of an organic thermal stabilizer (C) per 100 parts by mass of the polyamide (A).

(15) The polyamide composition according to (14), wherein the organic thermal stabilizer (C) is a sterically hindered phenol (C1).

(16) The polyamide composition according to (15), wherein the sterically hindered phenol (C1) contains at least one amide group.

(17) The polyamide composition according to any one of (10) to (16), also containing an azine-based dye or phthalocyanine-based dye (D).

(18) The polyamide composition according to (17), wherein the concentration of halide ions (F) measured by combustion ion chromatography relative to the mass of the azine-based dye or phthalocyanine-based dye (D) is less than 1% by mass.

(19) The polyamide composition according to any one of (10) to (18), also containing at least 0.001 parts by mass but not more than 0.5 parts by mass of a carbon black (E) per 100 parts by mass of the polyamide (A).

(20) The polyamide composition according to any one of (10) to (19), wherein the concentration of halide ions (F) measured by combustion ion chromatography relative to the total mass of the polyamide composition is not more than 500 ppm by mass.

(21) The polyamide composition according to any one of (10) to (20), also containing a filler (G).

### Advantageous Effects of Invention

The polyamide composition of the aspects described above is capable of yielding molded articles that exhibit excellent mechanical properties, excellent resistance to thermal aging at 180° C. for long periods of about 2,000 hours and excellent electrical characteristics, suppress the bleed out of additives at 80° C. and a relative humidity of 95%, resist elution of the additives into water, and also have excellent external appearance.

### DESCRIPTION OF EMBODIMENTS

Embodiments for implementing the present invention (hereinafter referred to as simply “embodiments of the present invention”) are described below in detail. However, the following embodiments of the present invention are provided merely as examples for describing the invention, and the present invention is in no way limited by the following content. The present invention may be implemented with appropriate modifications within the scope of the invention.

In the present description, the term “polyamide” means a polymer having an amide group (—NHCO—) within the main chain.

### <<Polyamide Composition (1)>>

A polyamide composition of one embodiment of the present invention contains:
a polyamide (A), and
also contains, per 100 parts by mass of the polyamide (A):
at least 0.1 parts by mass but not more than 3 parts by mass of a branched polyamine (B),
at least 0.05 parts by mass but not more than 3 parts by mass of a sterically hindered phenol (C), and
at least 0.01 parts by mass but not more than 0.5 parts by mass of an azine-based dye or phthalocyanine-based dye (D).

Further, the concentration of halide ions (F) measured by combustion ion chromatography relative to the total mass of the polyamide composition is not more than 500 ppm by mass.

As a result of having the composition described above, the polyamide composition of this embodiment of the present invention exhibits excellent resistance to thermal aging at 180° C. for long periods of about 2,000 hours and excellent electrical characteristics, suppresses the bleed out of additives at 80° C. and a relative humidity of 95%, and yields molded articles having excellent external appearance and laser marking properties.

In the following description, each of the aforementioned components from the polyamide (A) through to the azine-based dye or phthalocyanine-based dye (D) and the halide ions (F) are sometimes referred to as component (A) to component (D) and component (F) respectively.

Each of the constituent elements of the polyamide composition of this embodiment of the present invention are described below in further detail.

### <Polyamide (A)>

Examples of the polyamide (A) include: (a-1) polyamides obtained by ring-opening polymerization of a lactam, (a-2) polyamides obtained by self-condensation of a ω-aminocarboxylic acid, (a-3) polyamides obtained by condensation of a diamine and a dicarboxylic acid, and copolymers of these polyamides. A single polyamide may be used alone, or a combination of two or more polyamides may be used.

Examples of the lactam used in the production of the polyamide (a-1) include, but are not limited to, pyrrolidone, caprolactam, undecalactam, and dodecalactam.

Examples of the ω-aminocarboxylic acid used in the production of the polyamide (a-2) include, but are not limited to, ω-amino fatty acids produced by ring opening of the above lactams with water.

Further, a combination of two or more monomers may also be subjected to condensation as the above lactam or ω-aminocarboxylic acid.

Examples of the diamine (monomer) used in the production of the polyamide (a-3) include, but are not limited to, linear aliphatic diamines, branched aliphatic diamines, alicyclic diamines, and aromatic diamines.

Examples of the linear aliphatic diamines include, but are not limited to, hexamethylenediamine and pentamethylenediamine.

Examples of the branched aliphatic diamines include, but are not limited to, 2-methylpentanediamine and 2-ethylhexamethylenediamine.

Examples of the alicyclic diamines include, but are not limited to, cyclohexanediamine, cyclopentanediamine, and cyclooctanediamine.

Examples of the aromatic diamines include, but are not limited to, p-phenylenediamine and m-phenylenediamine.

Examples of the dicarboxylic acid (monomer) used in the production of the polyamide (a-3) include, but are not limited to, aliphatic dicarboxylic acids, alicyclic dicarboxylic acids, and aromatic dicarboxylic acids.

Examples of the aliphatic dicarboxylic acids include, but are not limited to, adipic acid, pimelic acid, and sebacic acid.

Examples of the alicyclic dicarboxylic acids include, but are not limited to, cyclohexanedicarboxylic acid.

Examples of the aromatic dicarboxylic acids include, but are not limited to, phthalic acid and isophthalic acid.

The diamine and dicarboxylic acid used as the above monomers may each be either a single compound or a combination of two or more compounds that are subjected to condensation.

Specific examples of the polyamide contained in the polyamide composition include polyamide 4 (poly-α-pyrrolidone), polyamide 6 (polycaproamide), polyamide 11 (polyundecanamide), polyamide 12 (polydodecanamide), polyamide 46 (polytetramethylene adipamide), polyamide 56 (polypentamethylene adipamide), polyamide 66 (polyhexamethylene adipamide), polyamide 610 (polyhexamethylene sebacamide), polyamide 612 (polyhexamethylene dodecamide), polyamide 6T (polyhexamethylene terephthalamide), polyamide 9T (polynonamethylene terephthalamide), and copolymer polyamides containing any of these polyamides as constituent components.

Among these, the polyamide is preferably polyamide 66 (PA66), polyamide 6 (PA6), polyamide 610 (PA610) or polyamide 612 (PA612). PA66 exhibits excellent heat resistance, moldability and toughness, and is an ideal material for vehicle components. Further, long-chain aliphatic polyamides such as PA610 and PA612 exhibit excellent chemical resistance.

Furthermore, from the viewpoints of heat resistance, moldability and toughness, the amount of PA66 relative to the total mass of the polyamide (A) is preferably at least 50% by mass, more preferably at least 60% by mass, even more preferably at least 70% by mass, still more preferably at least 80% by mass, particularly preferably at least 90% by mass, and most preferably 100% by mass.

### [Terminal Blocking Agent]

The terminals of the polyamide (A) may be blocked with a conventional terminal blocking agent.

These types of terminal blocking agents can also be added as molecular weight regulators during production of the polyamide from the aforementioned dicarboxylic acid and diamine, and if necessary, at least one of the aforementioned lactam and aminocarboxylic acid.

Examples of the terminal blocking agent include, but are not limited to, monocarboxylic acids, monoamines, acid anhydrides, monoisocyanates, monoacid halides, monoesters, and monoalcohols. Examples of the acid anhydrides include, but are not limited to, phthalic anhydride and the like. One of these terminal blocking agents may be used alone, or a combination of two or more such agents may be used.

Among the various possibilities, a monocarboxylic acid or monoamine is preferred as the terminal blocking agent. By blocking the terminals of the polyamide with a terminal blocking agent, a polyamide composition with even more superior thermal stability tends to be obtained.

Examples of monocarboxylic acids that can be used as the terminal blocking agent include any monocarboxylic acid that has reactivity with the amino group that may exist at the terminal of the polyamide. Specific examples of the monocarboxylic acid include, but are not limited to, aliphatic monocarboxylic acids, alicyclic monocarboxylic acids and aromatic monocarboxylic acids.

Examples of the aliphatic monocarboxylic acids include, but are not limited to, formic acid, acetic acid, propionic acid, butyric acid, valeric acid, caproic acid, caprylic acid, lauric acid, tridecylic acid, myristic acid, palmitic acid, stearic acid, pivalic acid, and isobutyric acid.

Examples of the alicyclic monocarboxylic acids include, but are not limited to, cyclohexanecarboxylic acid and the like.

Examples of the aromatic monocarboxylic acids include, but are not limited to, benzoic acid, toluic acid, α-naphthalenecarboxylic acid, β-naphthalenecarboxylic acid, methylnaphthalenecarboxylic acid, and phenylacetic acid.

One of these monocarboxylic acids may be used alone, or a combination of two or more such monocarboxylic acids may be used.

Examples of monoamines that can be used as the terminal blocking agent include any monoamine that has reactivity with the carboxy group that may exist at the terminal of the polyamide. Specific examples of the monoamine include, but are not limited to, aliphatic monoamines, alicyclic monoamines and aromatic monoamines.

Examples of the aliphatic amines include, but are not limited to, methylamine, ethylamine, propylamine, butylamine, hexylamine, octylamine, decylamine, stearylamine, dimethylamine, diethylamine, dipropylamine, and dibutylamine.

Examples of the alicyclic amines include, but are not limited to, cyclohexylamine and dicyclohexylamine.

Examples of the aromatic amines include, but are not limited to, aniline, toluidine, diphenylamine, and naphthylamine.

One of these monoamines may be used alone, or a combination of two or more such monoamines may be used.

Polyamide compositions containing the polyamide (A) having terminals blocked with the terminal blocking agent tend to exhibit even more superior levels of heat resistance, fluidity, toughness, low water absorption, and rigidity.

### [Amount of Polyamide (A)]

The amount of the polyamide (A) within the polyamide composition, expressed relative to the total mass of polyamide, may be, for example, at least 40.0% by mass but not more than 99.8% by mass, may be, for example, at least 50.0% by mass but not more than 90.0% by mass, or may be, for example, at least 55.0% by mass but not more than 80.0% by mass.

### [Method for Producing Polyamide (A)]

When producing the polyamide (A), the amount added of the dicarboxylic acid and the amount added of the diamine are preferably close to equimolar amounts. Allowing for some escape of the diamine outside the reaction system during the polymerization reaction when determining the molar ratio, the molar quantity of the total amount of diamine per 1 mol of the total amount of dicarboxylic acid is preferably at least 0.9 mol but not more than 1.2 mol, more preferably at least 0.95 mol but not more than 1.1 mol, and even more preferably at least 0.98 mol but not more than 1.05 mol.

Examples of the method used for producing the polyamide (A) are not limited to the following, but typically include a step of obtaining a polymer by polymerizing a dicarboxylic acid that constitutes the dicarboxylic acid units, a diamine that constitutes the diamine units, and if necessary at least one of a lactam that constitutes lactam units and an aminocarboxylic acid that constitutes aminocarboxylic acid units.

Further, the method for producing the polyamide preferably also includes a step of increasing the polymerization degree of the polyamide.

Furthermore, if necessary, the method may also include a blocking step of blocking the terminals of the obtained polymer with a terminal blocking agent.

There are a variety of specific method for producing the polyamide, including the following methods 1) to 4).
1) A method in which an aqueous solution of either a dicarboxylic acid-diamine salt, or a mixture of a dicarboxylic acid and a diamine, or a water suspension of these two compounds, is heated, and the polymerization is conducted while a melted state is maintained (hereinafter sometimes referred to as the “melt polymerization method”).
2) A method in which a polyamide obtained by the melt polymerization method undergoes an increase in the polymerization degree while the polyamide is held in a solid state at a temperature lower than the melting point (hereinafter sometimes referred to as the “melt polymerization-solid phase polymerization method”).
3) A method in which a dicarboxylic acid-diamine salt, or a mixture of a dicarboxylic acid and a diamine, is subjected to polymerization while a solid state is maintained (hereinafter sometimes referred to as the “solid-phase polymerization method”).
4) A method in which a polymerization is conducted using a dicarboxylic acid halide component equivalent to a dicarboxylic acid and a diamine component (hereinafter sometimes referred to as the “solution method”).

Among these methods, the method for producing the polyamide is preferably a production method that includes the melt polymerization method. Further, when the polyamide is produced using the melt polymerization method, the melted state is preferably maintained until the polymerization is complete. Examples of the method used for maintaining the melted state include production methods in which the polymerization conditions are adjusted to suit the polyamide composition. Examples of the polymerization conditions include the conditions and the like described below. First, the heating in the melt polymerization method is continued while the polymerization pressure is controlled to a value of at least 14 kg/cm² but not more than 25 kg/cm² (gauge pressure). Subsequently, by reducing the pressure inside the reaction tank down to atmospheric pressure (gauge pressure: 0 kg/cm²) over a period of at least 30 minutes, a polyamide of the desired composition can be obtained.

In the method for producing the polyamide, there are no particular limitations on the form of the polymerization, and either a batch system or a continuous system may be used.

The polymerization apparatus used in the production of the polyamide is not particularly limited, and conventional apparatus may be used, such as autoclave reactors, tumbler reactors, and extrusion reactors such as kneaders.

A method for producing the polyamide by a batch melt polymerization method is described below in detail as an example of the method for producing the polyamide, but the method for producing the polyamide is not limited to this particular method.

First, an aqueous solution containing about at least 40% by mass but not more than 60% by mass of the raw material components for the polyamide (the dicarboxylic acid, the diamine, and where necessary, at least one of a lactam and an aminocarboxylic acid) is concentrated to about at least 65% by mass but not more than 90% by mass in a concentration tank held at a temperature of at least 110° C. but not more than 180° C. and a pressure of about at least 0.035 MPa but not more than 0.6 MPa (gauge pressure), thus yielding a concentrated solution.

Next, the thus obtained concentrated solution is transferred to an autoclave, and heating is continued until the pressure inside the autoclave reaches about at least 1.2 MPa but not more than 2.2 MPa (gauge pressure).

Subsequently, the pressure in the autoclave is maintained at about at least 1.2 MPa but not more than 2.2 MPa (gauge pressure) while at least one of water and gaseous components are extracted, and when the temperature reaches about at least 220° C. but not more than 260° C., the pressure is reduced to atmospheric pressure (gauge pressure: 0 MPa).

Following reduction of the pressure inside the autoclave to atmospheric pressure, if necessary, the pressure may be reduced further, enabling by-product water to be to effectively removed.

Subsequently, the autoclave is pressurized with an inert gas such as nitrogen, and the polyamide melt is extruded from the autoclave as a strand. The extruded strand is then cooled and cut, yielding pellets of the polyamide.

### [Polymer Terminals of Polyamide (A)]

The polymer terminals of the polyamide (A) may be classified and defined as follows, although this is not a particular limitation of the invention.

In other words, the terminals may be classified as 1) an amino terminal, 2) a carboxy terminal, 3) a terminal blocking agent terminal, or 4) another terminal.
1) An amino terminal is a polymer terminal having an amino group (—NH₂ group), and is derived from a raw material diamine unit.
2) A carboxy terminal is a polymer terminal having a carboxy group (—COOH group), and is derived from the raw material dicarboxylic acid.
3) A terminal blocking agent terminal is a terminal formed when a terminal blocking agent is added during the polymerization. Examples of the terminal blocking agent include those described above.
4) Other terminals are polymer terminals that cannot be classified as any of the above 1) to 3). Specific examples of these other terminals include terminals that are produced when an amino terminal undergoes a deammoniation reaction, and terminals that are produced when a carboxy terminal undergoes a decarboxylation reaction.

### [Characteristics of Polyamide (A)]

### (Molecular Weight of Polyamide (A))

The weight average molecular weight Mw can be used as an indicator of the molecular weight of the polyamide. The weight average molecular weight Mw of the polyamide may be, for example, at least 10,000 but not more than 100,000, may be, for example, at least 15,000 but not more than 95,000, may be, for example, at least 20,000 but not more than 90,000, or may be, for example, at least 25,000 but not more than 85,000.

Measurement of the weight average molecular weight Mw can be conducted by gel permeation chromatography (GPC), as described below in the examples.

### (Molecular Weight Distribution of Polyamide (A))

The molecular weight distribution of the polyamide is indicated by the value of weight average molecular weight Mw/number average molecular weight Mn.

The Mw/Mn value for the polyamide may be 1.8 or greater, and for example, may be at least 1.8 but not more than 3.0, or at least 1.9 but not more than 2.5.

Examples of methods that may be used for controlling the value of Mw/Mn for the polyamide within the above range include methods in which a conventional polycondensation catalyst such as phosphoric acid or sodium hypophosphite is added as an additive during the polyamide melt polymerization, and methods in which the polymerization conditions such as the heating conditions and the reduced pressure conditions are controlled as appropriate.

The Mw/Mn value for the polyamide can be calculated using the weight average molecular weight Mw and the number average molecular weight Mn obtained using GPC, as described below in the examples.

### <Branched Polyamine (B)>

Examples of the branched polyamine (B) include polyalkyleneimines and polyalkylene polyamines. Examples of the polyalkyleneimines include polyethyleneimine and polytrimethyleneimine.

Among the various branched polyamines (B), in terms of resistance to thermal aging, and the strength and external appearance of the molded articles, a polyethyleneimine homopolymer or copolymer (Ba) is particularly preferred.

In this description, a “polyethyleneimine” describes homopolymers and copolymers obtained using the method described under the keyword “aziridine” in the electronic version of Ullman, or the method disclosed in International Patent Publication No. WO94/012560 (Reference Document 1).

In the following description, the “polyethyleneimine homopolymer or copolymer (Ba)” is sometimes referred to as simply the “polyethyleneimine (Ba)”.

Generally, an aforementioned ethyleneimine homopolymer can be obtained by polymerization of ethyleneimine (aziridine) in an aqueous solution or an organic solvent in the presence of a reaction initiator, an acid or a Lewi acid.

Ethyleneimine homopolymers obtained using this type of method are typically branched polymers containing primary, secondary and tertiary amino groups in a molar ratio of primary amino groups:secondary amino groups:tertiary amino groups=about 30%:40%:30%. The distribution of amino groups can be measured using ¹³C-NMR spectroscopy methods.

Examples of the comonomer used for forming an aforementioned ethyleneimine copolymer include amines having at least two amino groups, as described above.

Examples of this comonomer include, but are not limited to, alkylenediamines having at least 2 but not more than 10 C atoms within the alkylene group. Ethylenediamine or propylenediamine is particularly preferred.

Examples of other comonomers, besides those mentioned above, include diethylenetriamine, triethylenetetramine, tetraethylenepentamine, dipropylenetriamine, tripropylenetetramine, dihexamethylenetriamine, aminopropylethylenediamine, and bisaminopropylethylenediamine.

Other preferred polyethyleneimines (Ba), besides those mentioned above, include crosslinked polyethyleneimines obtained by reacting polyethyleneimine with a difunctional or polyfunctional crosslinking agent having at least one functional group selected from the group consisting of halohydrin groups, a glycidyl group, aziridinyl group, isocyanate unit, and halogen atoms.

Examples include epichlorohydrins of a polyalkylene glycol and at least 2 units but not more than 100 units of a unit selected from the group consisting of an ethylene oxide unit and a propylene oxide unit; bischlorohydrin ethers, and the compounds disclosed in German Patent Publication No. 19931720 (Reference Document 2) and U.S. Pat. No. 4,144,123 (Reference Document 3).

Examples of methods that may be used to produce crosslinked polyethyleneimines include the methods disclosed in the above reference documents, and methods disclosed in European Patent Publication No. 0895521 (Reference Document 4) and European Patent Publication No. 0025515 (Reference Document 5).

Moreover, additional preferred examples of the polyethyleneimine (Ba) include grafted polyethyleneimines.

Any compound that can react with an amino group or imino group of the polyethyleneimine may be used as the grafting agent.

The methods used for producing the grafting agent and the grafted polyethyleneimine may, for example, employ the methods disclosed in European Patent Publication No. 0675914 (Reference Document 6).

Furthermore, the polyethyleneimine (Ba) may be subjected to amidation by reaction with a carboxylic acid, an ester or anhydride of a carboxylic acid, a carboxylic acid amide or a carboxylic acid halide. The amidated polymer is subjected to subsequent crosslinking with a prescribed crosslinking agent in accordance with the proportion of amidated nitrogen atoms in the polyethyleneimine chain. At this time, in order to ensure adequate supply to the subsequent crosslinking reaction of at least one type of atom selected from the group consisting of a primary nitrogen atom and a secondary nitrogen atom, up to 30 mol % of the amino functional groups may be amidated. In other words, in the amidated polymer, in order to ensure the existence of an adequate amount of at least one type of atom selected from the group consisting of a primary nitrogen atom and a secondary nitrogen atom, it is preferable that 30 mol % or fewer of the amino functional groups in the amidated polymer have undergone amidation.

Carboxylic acids are totally eliminated by the amidation, and therefore the amidated polymer has no carboxylic acid terminal groups, and can be clearly differentiated from organic acids.

Further, the polyethyleneimine (Ba) may also be an alkoxylated polyethyleneimine obtained, for example, by reaction between a polyethyleneimine and at least one compound selected from the group consisting of ethylene oxide and propylene oxide. This type of alkoxylated polymer can be subjected to subsequent crosslinking.

Furthermore, from thew viewpoint of affinity with polyamide resins, the polyethyleneimine (Ba) may also be a hydroxy group-containing polyethyleneimine, an amphoteric polyethylene (incorporating anionic functional groups), or a lipophilic polyethyleneimine typically obtained by incorporation of a long-chain hydrocarbon group into the polymer chain. Methods for producing these types of polyethyleneimine polymers are well known by those skilled in the field.

### [Characteristics of Polyethyleneimine (Ba)]

### (Weight Average Molecular Weight of Polyethyleneimine (Ba))

The weight average molecular weight of the polyethyleneimine (Ba) is preferably at least 100 but not more than 3,000,000, more preferably at least 200 but not more than 2,000,000, even more preferably at least 300 but not more than 20,000, particularly preferably at least 400 but not more than 2,000, and most preferably at least 700 but not more than 1,000.

By ensuring that the weight average molecular weight of the polyethyleneimine (Ba) is at least as large as the above lower limit, the resistance to thermal aging can be further improved. On the other hand, by ensuring that the weight average molecular weight of the polyethyleneimine (Ba) is not more than the above upper limit, the external appearance upon production of a molded article can be further improved.

The weight average molecular weight of the polyethyleneimine (Ba) can be measured by the light scattering method.

### (Viscosity of Polyethyleneimine (Ba))

The viscosity of the polyethyleneimine (Ba) is preferably at least 1,000 mPa·s but not more than 2,500 mPa·s, more preferably at least 1,200 mPa·s but not more than 2,300 mPa·s, even more preferably at least 1,200 mPa·s but not more than 2,100 mPa·s, and particularly preferably at least 1,400 mPa·s but not more than 1,900 mPa·s.

By ensuring that the viscosity of the polyethyleneimine (Ba) is at least as high as the above lower limit, the resistance to thermal aging and the mechanical properties can be further improved.

By ensuring that the viscosity of the polyethyleneimine (Ba) is not more than the above upper limit, the resistance to thermal aging and the external appearance upon production of a molded article can be further improved, and the polyethyleneimine (B) incorporated within the molded article becomes more resistant to elution with water.

The viscosity of the polyethyleneimine (Ba) can be measured at 20° C. in accordance with ISO 2555 using a Brookfield viscometer.

### [Amount of Polyethyleneimine (Ba)]

In the polyamide composition of an embodiment of the present invention, from the viewpoints of the resistance to thermal aging, the external appearance, the strength and the rigidity upon production of a molded article, the amount of the polyethyleneimine (Ba), per 100 parts by mass of the polyamide (A), may be at least 0.1 parts by mass but not more than 3 parts by mass, and is preferably at least 0.2 parts by mass but not more than 2 parts by mass, and more preferably at least 0.3 parts by mass but not more than 1.4 parts by mass.

By ensuring that the amount of the polyethyleneimine (Ba) is at least as large as the above lower limit, the resistance to thermal aging and the external appearance can be further improved. On the other hand, by ensuring that the amount of the polyethyleneimine (Ba) is not more than the above upper limit, the strength and the rigidity and the like upon production of a molded article are improved.

### <Sterically Hindered Phenol (C)>

By including the sterically hindered phenol (C) in the polyamide composition of an embodiment of the present invention, the resistance to thermal aging upon production of a molded article is superior, and the bleed out of additives at 80° C. and a relative humidity of 95% can be better suppressed.

Examples of the sterically hindered phenol (C) include, but are not limited to, N,N′-hexamethylenebis[3-(3,5-di-tert-butyl-4-hydroxyphenyl)propanamide], triethylene glycol bis[3-(3-tert-butyl-5-methyl-4-hydroxyphenyl)propionate, 4,4′-butylidenebis(3-methyl-6-tert-butylphenol), 1,6-hexanediol bis[3-(3,5-di-tert-butyl-4-hydroxyphenyl)propionate, 2,4-bis(n-octylthio)-6-(4-hydroxy-3,5-di-tert-butylanilino)-1,3,5-triazine, pentaerythritol tetrakis[3-(3,5-di-tert-butyl-4-hydroxyphenyl)propionate], 2,2-thio-diethylenebis[3-(3,5-di-tert-butyl-4-hydroxyphenyl)propionate], octadecyl-3-(3,5-di-tert-butyl-4-hydroxyphenyl)propionate, 2,2-thiobis(4-methyl-6-1-butylphenol), N,N′-hexamethylenebis(3,5-di-tert-butyl-4-hydroxy-hydroxycinnamide), 3,5-di-tert-butyl-4-hydroxy-benzylphosphonate diethyl ester, 1,3,5-trimethyl-2,4,6-tris(3,5-dibutyl-4-hydroxybenzyl)benzene, calcium bis(ethyl 3,5-di-tert-butyl-4-hydroxybenzylsulfonate), tris(3,5-di-tert-butyl-4-hydroxybenzyl) isocyanurate, 2,6-di-tert-butyl-p-cresol, butylated hydroxyanisole, 2,6-di-tert-butyl-4-ethylphenol, stearyl-β-(3,5-di-tert-butyl-4-hydroxyphenyl)propionate, 2,2′-methylenebis-(4-methyl-6-tert-butylphenol), 2,2′-methylenebis-(4-ethyl-6-tert-butylphenol), 4,4′-thiobis(3-methyl-6-tert-butylphenol), octylated diphenylamine, 2,4-bis[(octylthio)methyl]-o-cresol, isooctyl-3-(3,5-di-tert-butyl-4-hydroxyphenyl)propionate, 4,4′-butylidenebis(3-methyl-6-tert-butylphenol), 3,9-bis[1,1-dimethyl-2-[β-(3-tert-butyl-4-hydroxy-5-methylphenyl)propionyloxy]ethyl]-2,4,8,10-tetraoxaspiro[5.5]undecane, 1,1,3-tris(2-methyl-4-hydroxy-5-tert-butylphenyl)butane, 1,3,5-trimethyl-2,4,6-tris(3,5-di-tert-butyl-4-hydroxybenzyl)benzene, bis[3,3′-bis(4′-hydroxy-3′-tert-butylphenyl)butyric acid]glycol ester, 1,3,5-tris(3′,5′-di-tert-butyl-4′hydroxybenzyl)-sec-triazine-2,4,6-(1H,3H,5H)trione, and d-α-tocopherol.

Among the various sterically hindered phenols (C) listed above, a sterically hindered phenol having at least one amide group is preferred, and N,N′-hexamethylenebis[3-(3,5-di-tert-butyl-4-hydroxyphenyl)propanamide] is particularly preferred. Compared with sterically hindered phenols (C) that do not have am amide group, a sterically hindered phenol (C) having at least one amide group undergoes stronger interaction with the azine-based dye or phthalocyanine-based dye (D), meaning bleed out of the sterically hindered phenol (C) can be more effectively suppressed.

### [Amount of Sterically Hindered Phenol (C)]

In the polyamide composition of an embodiment of the present invention, from the viewpoints of resistance to thermal aging and suppression of bleed out upon production of a molded article, the amount of the sterically hindered phenol (C), per 100 parts by mass of the polyamide (A), may be at least 0.05 parts by mass but not more than 3 parts by mass, and is preferably at least 0.1 parts by mass but not more than 2 parts by mass, and more preferably at least 0.2 parts by mass but not more than 1.5 parts by mass.

By ensuring that the amount of the sterically hindered phenol (C) is at least as large as the above lower limit, the resistance to thermal aging can be further improved. On the other hand, by ensuring that the amount of the sterically hindered phenol (C) is not more than the above upper limit, bleed out can be better suppressed.

In the polyamide composition of an embodiment of the present invention, from the viewpoints of the resistance to thermal aging, the mechanical properties and suppression of bleed out upon production of a molded article, the weight ratio between the branched polyamine (B) and the sterically hindered phenol (C) is preferably within a range from 0.06 to 30, more preferably from 0.3 to 8.0, and even more preferably from 0.67 to 5.0.

By ensuring that the weight ratio between the branched polyamine (B) and the sterically hindered phenol (C) is at least as large as the above lower limit, the resistance to thermal aging can be improved, and bleed out of the sterically hindered phenol (C) can be prevented. On the other hand, by ensuring that the weight ratio between the branched polyamine (B) and the sterically hindered phenol (C) is not more than the above upper limit, the resistance to thermal aging and the mechanical properties can be improved.

### <Azine-Based Dye or Phthalocyanine-Based Dye (D)>

By incorporating the azine-based dye or phthalocyanine-based dye (D) in the polyamide composition of an embodiment of the present invention, the dye can function as a crystallization retardant, hereby further improving the external appearance of the molded article.

The azine-based dye is preferably nigrosin, and the phthalocyanine-based dye is preferably a copper phthalocyanine-based dye.

By interacting with the sterically hindered phenol (C), the azine-based dye or phthalocyanine-based dye (D) has the effect of suppressing bleed out of the sterically hindered phenol (C). From the viewpoint of the size of this bleed out suppression effect, an azine-based dye is preferably used as the component (D), and nigrosin is particularly preferred. In such cases, the sterically hindered phenol (C) having an amide group undergoes a strong interaction with the nigrosin, thereby better suppressing bleed out of the sterically hindered phenol (C).

### [Amount of the Azine-Based Dye or Phthalocyanine-Based Dye (D)]

In the polyamide composition of an embodiment of the present invention, the amount of the azine-based dye or phthalocyanine-based dye (D), per 100 parts by mass of the polyamide (A), may be at least 0.01 parts by mass but not more than 0.5 parts by mass, and is preferably at least 0.05 parts by mass but not more than 0.32 parts by mass, and more preferably at least 0.08 parts by mass but not more than 0.2 parts by mass.

By ensuring that the amount of the azine-based dye or phthalocyanine-based dye (D) is at least as large as the above lower limit, the external appearance upon production of a molded article can be improved, and bleed out of the sterically hindered phenol (C) can be prevented. On the other hand, by ensuring that the amount of the azine-based dye or phthalocyanine-based dye (D) is not more than the above upper limit, any deterioration in the strength and rigidity and the like of the molded article tends to be preventable.

In the polyamide composition of an embodiment of the present invention, the weight ratio between the sterically hindered phenol (C) and the azine-based dye or phthalocyanine-based dye (D) is preferably within a range from 0.5 to 60, more preferably from 1.0 to 20, and even more preferably from 1.67 to 12.

By ensuring that the weight ratio between the sterically hindered phenol (C) and the azine-based dye or phthalocyanine-based dye (D) is at least as large as the above lower limit, the tensile strength can be increased. By ensuring that the weight ratio between the sterically hindered phenol (C) and the azine-based dye or phthalocyanine-based dye (D) is not more than thew above upper limit, bleed out of the sterically hindered phenol (C) can be better prevented.

### [Amount of Halide Ions]

The azine-based dye or phthalocyanine-based dye (D) may sometimes contain halide ions. Because halide ions can cause a deterioration in the electrical characteristics, the concentration of halide ions within the azine-based dye or phthalocyanine-based dye (D), expressed relative to the mass of the azine-based dye or phthalocyanine-based dye (D), is preferably less than 1% by mass, more preferably less than 0.6% by mass, and even more preferably less than 0.2% by mass. This halide ion concentration is measured by combustion ion chromatography.

### <Carbon Black (E)>

The polyamide composition of an embodiment of the present invention may also contain a carbon black (E). By including the carbon black (E), a composition with superior laser marking properties can be obtained. Further, by using the carbon black (E) in combination with the azine-based dye or phthalocyanine-based dye (D), even if the carbon black (E) functions as a crystal nucleating agent, the crystallization retardation effect of the azine-based dye or phthalocyanine-based dye (D) enables favorable external appearance to be obtained upon production of a molded article.

Here, laser marking refers to using a laser to print a product name, production number and/or precautionary notes on the molded article. In order to enable laser marking, a black additive such as the carbon black (E) is used as an additive that absorbs the laser light.

However, these additives that absorb laser light can also function as crystal nucleating agents, thereby accelerating crystallization of the matrix resin. As a result, they tend to promote deterioration in the external appearance of the molded article.

In the polyamide composition of an embodiment of the present invention, when the component (D) is also used, even if the carbon black (E) functions as a crystal nucleating agent, the crystallization retardation effect of the component (D) enables favorable external appearance to be obtained upon production of a molded article.

Examples of the carbon black (E) include acetylene black, lamp black, thermal black, furnace black, channel black, Ketjen black, gas black, and oil black. One of these carbon blacks (E) may be used alone, or a combination of two or more such carbon blacks may be used.

### [Amount of Carbon Black (E)]

In the polyamide composition of an embodiment of the present invention, the amount of the carbon black (E), per 100 parts by mass of the polyamide (A), is preferably at least 0.01 parts by mass but not more than 0.5 parts by mass, more preferably at least 0.05 parts by mass but not more than 0.25 parts by mass, and even more preferably at least 0.1 parts by mass but not more than 0.2 parts by mass.

By ensuring that the amount of the carbon black (E) is at least as large as the above lower limit, the laser heating effect is increased, and the laser marking properties improve. On the other hand, by ensuring that the amount of the carbon black (E) is not more than the above upper limit, carbonization of the resin caused by the heating can be prevented.

### <Halide Ions (F)>

In the polyamide composition of an embodiment of the present invention, the concentration of halide ions (F), expressed relative to the total mass of the polyamide composition, is typically not more than 500 ppm by mass, and is preferably not more than 400 ppm by mass, more preferably not more than 300 ppm by mass, even more preferably not more than 200 ppm by mass, and particularly preferably 100 ppm by mass or lower.

On the other hand, although the lower limit for the concentration of halide ions (F) is preferably as low as possible, for example, it may be 0.0 ppm by mass, 0.1 ppm by mass, or 1 ppm by mass.

In the polyamide composition of an embodiment of the present invention, depending on the production methods employed, the components (A) to (E) may incorporate halide ions as impurities. In the polyamide composition of an embodiment of the present invention, if the amount of halide ions (F) exceeds the above upper limit, then there is a possibility that the electrical characteristics such as the volume resistivity and tracking resistance may be impaired. Accordingly, by suppressing the amount of halide ions (F) incorporated within each of the components (A) to (E), and ensuring that the concentration of halide ions (F) incorporated within the polyamide composition is not more than the above upper limit, a polyamide composition can be obtained that yields superior electrical characteristics upon production of a molded article.

### <Filler (G)>

In addition to the components (A) to (E), the polyamide composition of an embodiment of the present invention preferably also contains a filler (G). By including the filler (G) in the polyamide composition of an embodiment of the present invention, the mechanical properties such as the strength and rigidity can be further improved upon production of a molded article.

Examples of the filler (G) include, but are not limited to, glass fiber, carbon fiber, calcium silicate fiber, potassium titanate fiber, aluminum borate fiber, glass flakes, calcium carbonate, talc, kaolin, mica, hydrotalcite, zinc carbonate, calcium hydrogen phosphate, wollastonite, zeolite, boehmite, magnesium oxide, calcium silicate, sodium aluminosilicate, magnesium silicate, Ketjen black, acetylene black, furnace black, carbon nanotubes, graphite, brass, copper, silver, aluminum, nickel, iron, calcium fluoride, montmorillonite, swellable fluorine mica, apatite, and milled fiber. One of these fillers (G) may be used alone, or a combination of two or more such fillers may be used.

Among the various possibilities, from the viewpoints of rigidity and strength and the like, the filler (G) is preferably glass fiber, carbon fiber, glass flakes, talc, kaolin, mica, calcium hydrogen phosphate, wollastonite, carbon nanotubes, graphite, calcium fluoride, montmorillonite, swellable fluorine mica or apatite.

Furthermore, the filler (G) is more preferably one or more fillers selected from the group consisting of glass fiber, calcium carbonate, talc, mica, wollastonite and milled fiber, even more preferably glass fiber or carbon fiber, and most preferably glass fiber.

In those cases where the filler (G) is glass fiber or carbon fiber, the number average fiber diameter (d1) is preferably at least 3 μm but not more than 30 μm. Further, the weight average fiber length (L) is preferably at least 100 μm but not more than 5 mm. Moreover, the aspect ratio ((L)/(d1)) of the weight average fiber length (L) relative to the number average fiber diameter (d1) is preferably at least 10 but not more than 100. By using glass fiber or carbon fiber of the above shape, superior characteristics can be achieved.

Further, in those cases where the filler (G) is glass fiber, the number average fiber diameter (d1) is more preferably at least 3 μm but not more than 30 μm. The weight average fiber length (L) is preferably at least 103 μm but not more than 5 mm. Moreover, the aspect ratio ((L)/(d1)) is more preferably at least 3 but not more than 100.

The number average fiber diameter and the weight average fiber length of the filler (G) can be measured using the method described below.

First, the molded article is dissolved in a solvent such as formic acid capable of dissolving the polyamide (A). Next, for example, at least 100 fibers of the filler (G) are selected randomly from the resulting insoluble component. Subsequently, the selected fibers of the filler (G) are inspected using an optical microscope or a scanning electron microscope or the like, and the number average fiber diameter can be determined by dividing the total of all the measured fiber diameters by the number of measured fibers of the filler (G). Alternatively, the weight average fiber length can be determined by dividing the total of all the measured fiber lengths by the total weight of all the measured fibers of the filler (G).

### [Amount of Filler (G)]

In the polyamide composition of an embodiment of the present invention, the amount of the filler (G), per 100 parts by mass of the polyamide (A), is preferably at least 0 parts by mass but not more than 150 parts by mass, more preferably at least 10 parts by mass but not more than 140 parts by mass, even more preferably at least 20 parts by mass but not more than 135 parts by mass, particularly preferably at least 25 parts by mass but not more than 130 parts by mass, and most preferably at least 30 parts by mass but not more than 100 parts by mass.

By ensuring that the amount of the filler (G) is at least as large as the above lower limit, the mechanical properties such as the strength and the rigidity of the molded article tend to be further improved. On the other hand, by ensuring that the amount of the filler (G) is not more than the above upper limit, a molded article tends to be obtained that exhibits more superior surface external appearance and superior laser marking properties.

Particularly in those cases where the filler (G) is glass fiber, by ensuring that the amount of the filler (G) per 100 parts by mass of the polyamide (A) falls within the above range, the mechanical properties such as the strength and the rigidity of the molded article tend to be able to be improved even further.

### <Other Additives>

The polyamide composition may contain other additives typically used in polyamides, provided they do not impair the objects of the embodiment of the present invention. Examples of these other additives include fibrillation agents, lubricants, fluorescent whiteners, plasticizers, ultraviolet absorbers, antistatic agents, fluidity improvers, reinforcing agents, spreading agents, nucleating agents, rubbers, strengthening agents, and other polymers. The amounts of these other additives within the polyamide composition of an embodiment of the present invention may be set appropriately by a person skilled in the art in accordance with their intended effect.

### <Method for Producing Polyamide Composition>

In the method for producing the polyamide composition, there are no particular limitations on the method used for adding each of the constituent components, provided that the components (A) to (E), and if necessary the component (G) and one or more of the other additives mentioned above, are mixed together.

Examples of the method used for mixing the constituent materials include a method in which the materials are mixed using a Henschel mixer or the like, and the mixture is then supplied to a melt kneading apparatus and kneaded, and a method in which the component (A) and the components (B) to (E) that have been converted to a melted state using a single-screw or twin-screw extruder are supplied from a top feeder, and if necessary, the filler (C) and the other additives (D) are blended into the mixture from a side feeder.

In terms of the method used for supplying the components that constitute the polyamide composition to the melt kneading apparatus, all of the constituent components may be supplied at once to a single supply port, or the components (A) to (E), and if necessary the component (G), may be supplied from mutually different supply ports.

The melt kneading temperature, expressed as the resin temperature, is preferably at least 250° C. but not higher than about 375° C.

The melt kneading time is preferably at least 0.5 minutes but not more than about 5 minutes.

There are no particular limitations on the apparatus used for conducting the melt kneading, and conventional melt kneading apparatus such as a single-screw or twin-screw extruder, Banbury mixer or mixing roller may be used.

### <<Polyamide Composition (2)>>

A polyamide composition of another embodiment of the present invention contains:
a polyamide (A), and
at least 0.1 parts by mass but not more than 3 parts by mass of a branched polyamine (B) per 100 parts by mass of the polyamide (A).

Further, the viscosity of the branched polyamine (B) at 20° C. measured using a Brookfield viscometer in accordance with ISO 2555 is at least 1,000 mPa·s but not more than 2,500 mPa·s.

As a result of having the composition described above, the polyamide composition of this embodiment of the present invention exhibits excellent resistance to thermal aging, excellent electrical characteristics and external appearance, and superior mechanical properties, and yields molded articles that resist elution of the additives into water.

Each of the constituent elements of the polyamide composition of this embodiment of the present invention are described below in further detail.

### [Polyamide (A)]

In the polyamide composition of this embodiment of the present invention, the polyamide (A) is as disclosed above in the section entitled <Polyamide (A)> in the description of the <<Polyamide Composition (1)>>.

### [Branched Polyamine (B)]

In the polyamide composition of this embodiment of the present invention, the branched polyamine (B) is as disclosed above in the section entitled <Branched Polyamine (B)> in the description of the <<Polyamide Composition (1)>>.

### [Organic Thermal Stabilizer (C)]

The polyamide composition of this embodiment of the present invention may also contain an organic thermal stabilizer (C). By including the organic thermal stabilizer (C), the resistance to thermal aging upon production of a molded article can be further improved.

In the polyamide composition of this embodiment, from the viewpoints of the resistance to thermal aging and bleed out suppression upon production of a molded article, the amount of the organic thermal stabilizer (C), per 100 parts by mass of the polyamide (A), is preferably at least 0.05 parts by mass but not more than 3 parts by mass, more preferably at least 0.1 parts by mass but not more than 2 parts by mass, and particularly preferably at least 0.2 parts by mass but not more than 1.5 parts by mass.

By ensuring that the amount of the organic thermal stabilizer (C) is at least as large as the above lower limit, the resistance to thermal aging improves. On the other hand, by ensuring that the amount of the organic thermal stabilizer (C) is not more than the above upper limit, bleed out can be better suppressed.

There are no particular limitations on the organic thermal stabilizer (C), and examples of materials that may be used include sterically hindered phenol-based organic thermal stabilizers, phosphorus-based organic thermal stabilizers, aromatic amine-based organic thermal stabilizers, and sterically hindered amine-based organic thermal stabilizers. Among these, a sterically hindered phenol-based organic thermal stabilizer is preferred as the organic thermal stabilizer (C). The sterically hindered phenol-based organic thermal stabilizer is sometimes referred to as the “sterically hindered phenol (C1)”.

The sterically hindered phenol (C1) is as disclosed above in the section entitled <Sterically Hindered Phenol (C)> in the description of the <<Polyamide Composition (1)>>.

### [Azine-Based Dye or Phthalocyanine-Based Dye (D)]

In the polyamide composition of this embodiment of the present invention, an azine-based dye or phthalocyanine-based dye (D) is as disclosed above in the section entitled <Azine-based Dye or Phthalocyanine-based Dye (D)> in the description of the <<Polyamide Composition (1)>>.

### [Carbon Black (E)]

In the polyamide composition of this embodiment of the present invention, a carbon black (E) is as disclosed above in the section entitled <Carbon Black (E)> in the description of the <<Polyamide Composition (1)>>.

However, in the polyamide composition of this embodiment of the present invention, the amount of the carbon black (E), per 100 parts by mass of the polyamide (A), is typically at least 0.001 parts by mass but not more than 0.5 parts by mass, preferably at least 0.005 parts by mass but not more than 0.25 parts by mass, and more preferably at least 0.01 parts by mass but not more than 0.2 parts by mass.

By ensuring that the amount of the carbon black (E) is at least as large as the above lower limit, the laser heating effect is increased, and the laser marking properties improve. On the other hand, by ensuring that the amount of the carbon black (E) is not more than the above upper limit, carbonization of the resin caused by the heating can be prevented.

### [Halide Ions (F)]

In the polyamide composition of this embodiment of the present invention, halide ions (F) are as disclosed above in the section entitled <Halide Ions (F)> in the description of the <<Polyamide Composition (1)>>.

### [Filler (G)]

In the polyamide composition of this embodiment of the present invention, the filler (G) is as disclosed above in the section entitled <Filler (G)> in the description of the <<Polyamide Composition (1)>>.

### <Usage Applications>

Molded articles obtained from the polyamide composition of an embodiment of the present invention can be used favorably as material components in a variety of applications, including vehicles, the machine industry, electrical and electronic applications, industrial materials, building materials, daily commodities, and household items. Among these, because the molded articles exhibit excellent resistance to thermal aging and superior electrical characteristics, they can be used particularly favorably as vehicle components.

### EXAMPLES

The present invention is described below in further detail using specific examples and comparative examples, but the present invention is not limited to the following examples.

Each of the constituent components of the resin compositions used in the examples and comparative examples is described below.

### <Constituent Components>

### [Polyamides (A)]

A-1: polyamide 66 (PA66)
A-2: polyamide 66 (PA66)
A-3: polyamide 6 (PA6) (SF1013, manufactured by UBE Corporation)

Synthesis methods for the polyamides A-1 and A-2 are described below. The obtained polyamides A-1 and A-2 were dried under a nitrogen stream to reduce the water content to about 0.1% by mass, before being used as raw materials for the polyamide compositions.

### [Branched Polyamines (B)]

B-1: Lupasol (a registered trademark) FG (manufactured by BASF Corporation, weight average molecular weight: 800, viscosity: 1,680 mPa·s)
B-2: EPOMIN (a registered trademark) SP-006 (manufactured by Nippon Shokubai Co., Ltd., number average molecular weight: 600, viscosity: 2,900 mPa·s)
B-3: Lupasol (a registered trademark) G20 WF (manufactured by BASF Corporation, weight average molecular weight: 1,300, viscosity: 8,000 mPa·s)
B-4: EPOMIN (a registered trademark) SP-003 (manufactured by Nippon Shokubai Co., Ltd., number average molecular weight: 300, viscosity: 300 mPa·s)

### [Sterically Hindered Phenol (C)]

C-1: N,N′-hexane-1,6-diylbis(3-(3,5-di-tert-butyl-4-hydroxyphenylpropionamide)) (manufactured by BASF Corporation, product name: Irganox (a registered trademark) 1098, contains amide groups)
C-2: 3,9-bis{2-[3-(3-tert-butyl-4-hydroxy-5-methylphenyl)propionyloxy]-1,1-dimethylethyl}-2,4,8,10-tetraoxaspiro[5.5]undecane (manufactured by ADEKA Corporation, product name: ADEKA STAB (a registered trademark) AO-80, no amide groups)

### [Thermal Stabilizers (C′)]

C′-1: a hindered amine-based thermal stabilizer (manufactured by Clariant AG, product name: Nylostab (a registered trademark) S-EED)
C′-2: an aromatic amine-based thermal stabilizer (manufactured by Ouchi Shinko Chemical Industrial Co., Ltd., product name: Nocrac CD)
C′-3: an aromatic amine-based thermal stabilizer (manufactured by Ouchi Shinko Chemical Industrial Co., Ltd., product name: Nocrac 224)
C′-4: a mixture of copper iodide and potassium iodide

### [Azine-Based Dye or Phthalocyanine-Based Dye (D)]

D-1: a nigrosin dye (TH807, manufactured by Orient Chemical Industries Co., Ltd. (halide ion concentration: 0.06% by mass)
D-2: a nigrosin dye (TH870, manufactured by Orient Chemical Industries Co., Ltd. (halide ion concentration: 1.6% by mass)

### [Carbon Black (E)]

E-1: carbon black (primary particle size: 27 nm)

### [Filler (G)]

G-1: glass fiber (GF) (manufactured by Nippon Electric Glass Co., Ltd., product name: ECS03T275H, average fiber diameter: 10 μm, cut length: 3 mm)

### <Synthesis of Polyamides (A)>

### Synthesis Example 1

### (Synthesis of Polyamide A-1 (PA66))

The polyamide polymerization reaction was conducted using the melt polymerization method in the manner described below.

First, 1,500 g of an equimolar salt of adipic acid and hexamethylenediamine was dissolved in 1,500 g of distilled water, producing an equimolar 50% by mass uniform aqueous solution of the raw material monomers. This aqueous solution was placed in an autoclave with an internal capacity of 5.4 L, and the inside of the autoclave was flushed with nitrogen. Next, with the aqueous solution undergoing stirring at a temperature of at least 110° C. but not more than 150° C., the solution was concentrated by gradually removing water vapor until the solution concentration reached 70% by mass. Subsequently, the internal temperature was raised to 220° C. At this time, the pressure inside the autoclave rose to 1.8 MPa. With the pressure held at 1.8 MPa, the mixture was reacted for one hour while water vapor was gradually removed, until the internal temperature reached 245° C. The pressure was then reduced over a period of one hour. Next, using a vacuum device, the inside of the autoclave was held for 10 minutes at a reduced pressure of 650 torr (86.66 kPa). At this time, the final internal temperature of the polymerization was 265° C. Subsequently, the autoclave was pressurized with nitrogen, and the product was extruded from a lower spinneret (nozzle) in a strand-like form, cooled in water, and then cut and discharged as pellets, which were dried at 100° C. in a nitrogen atmosphere for 12 hours to obtain the polyamide A-1 (PA66).

The thus obtained polyamide A-1 (PA66) had a weight average molecular weight of 35,000 and a molecular weight distribution (Mw/Mn) of 2.0

### Synthesis Example 2

### (Synthesis of Polyamide A-2 (PA66))

The polyamide polymerization reaction was conducted using the melt polymerization method in the manner described below.

First, 1,500 g of an equimolar salt of adipic acid and hexamethylenediamine was dissolved in 1,500 g of distilled water, producing an equimolar 50% by mass uniform aqueous solution of the raw material monomers. This aqueous solution was placed in an autoclave with an internal capacity of 5.4 L. Copper iodide and potassium iodide were added, and the inside of the autoclave was then flushed with nitrogen. Next, with the aqueous solution undergoing stirring at a temperature of at least 110° C. but not more than 150° C., the solution was concentrated by gradually removing water vapor until the solution concentration reached 70% by mass. Subsequently, the internal temperature was raised to 220° C. At this time, the pressure inside the autoclave rose to 1.8 MPa. With the pressure held at 1.8 MPa, the mixture was reacted for one hour while water vapor was gradually removed, until the internal temperature reached 245° C. The pressure was then reduced over a period of one hour. Next, using a vacuum device, the inside of the autoclave was held for 10 minutes at a reduced pressure of 650 torr (86.66 kPa). At this time, the final internal temperature of the polymerization was 265° C. Subsequently, the autoclave was pressurized with nitrogen, and the product was extruded from a lower spinneret (nozzle) in a strand-like form, cooled in water, and then cut and discharged as pellets, which were dried at 100° C. in a nitrogen atmosphere for 12 hours to obtain the polyamide A-2 (PA66).

The thus obtained polyamide A-2 (PA66) had a weight average molecular weight of 35,000 and a molecular weight distribution (Mw/Mn) of 2.0

### <Production of Polyamide Compositions>

### Examples 1 to 22 and Comparative Example 1

Using a TEM 35 mm twin-screw extruder manufactured by Shibaura Machine Co., Ltd. (set temperature: 290° C., screw rotation rate: 300 rpm), the component (A), the component (B), the component (C) or (C′), the component (D) and the component (E) were supplied to the top feed port provided at the most upstream section of the extruder in the blend amounts shown in Table 1 to Table 4. Further, the component (G) was supplied from a side feed port further downstream the extruder (where the resins supplied from the top feed port had already reached an adequately melted state). Subsequently, the melt kneaded product extruded from the die head was cooled in a strand-like form and then pelletized to obtain pellets of the polyamide composition.

### <Method for Measuring Physical Properties>

### [Physical Property 1]

### (Concentration of Halide Ions)

The concentration of halide ions (Cl⁻, Br⁻, I⁻) contained in the pellets of the polyamide composition was quantified by combustion ion chromatography. Specifically, using an AQF-2100H apparatus manufactured by Mitsubishi Chemical Analytech Co., Ltd., a sample was produced by a combustion tube combustion method using ultrapure water (containing hydrogen peroxide water and hydrazine hydrate) as the absorbent. An Integrion RFIC manufactured by Thermo Fisher Scientific Inc. was used as the ion chromatography (IC) apparatus, an IonPac AS18-4 μm (4 mmø×150 mm) manufactured by Thermo Fisher Scientific Inc. was used as the column, a KOH aqueous solution was used as the eluent, and a UV detector was used as the detector.

Based on the measurement results, the formula shown below was used to calculate the concentration of halide ions (Cl⁻, Br⁻, I⁻). Specifically, using the formula below, the concentrations of Cl⁻, Br⁻ and I⁻ in the sample were each calculated, and the total of those calculated concentration values was used as the concentration of halide ions.

$$Concentration ( ppm by mass ) of {Cl}^{-} , {Br}^{-} or {I}^{-} = [ ( IC measured value ( mg / L ) ) \times ( dilution rate ) - ( blank IC measured value ( mg / L ) ) ] \times [ ( absorbent volume ( mL ) ) / \\ 1 , 000 ] \times [ 1 , 000 , 000 / ( sample mass ( mg ) ) ]$$

### <Evaluation Methods>

### [Production of Multipurpose Test Piece]

The pellets of the polyamide composition were dried under a stream of nitrogen, and the water content within the polyamide composition was reduced to 500 ppm by mass. Subsequently, the pellets of each polyamide composition for which the water content had been adjusted in this manner were molded into a multipurpose test piece (type A, a dumbbell-shaped tensile test piece) in accordance with ISO 3167 using an injection molding device (PS-40E, manufactured by Nissei Plastic Industrial Co., Ltd.). The dimensions of the multipurpose test piece were total length: >170 nm, distance between tabs: 109.3±3.2 mm, length of parallel portion: 80±2 mm, radius of shoulder portion: 24±1 mm, width of end portions: 20±0.2 mm, width of central parallel portion: 10±0.2 mm, and thickness: 4±0.2 mm. Specific conditions during the injection molding included an injection and pressure holding time of 25 seconds, a cooling time of 15 seconds, a mold temperature of 80° C., and a cylinder temperature of 290° C.

### [Evaluation 1]

### (Tensile Strength and Resistance to Thermal Aging)

Using each of the multipurpose test pieces (type A), a tensile test was conducted in accordance with ISO 527 at a tensile speed of 5 mm/minute, thus measuring the initial tensile strength (S0) (MPa). Next, the multipurpose test piece (type A) was subjected to a thermal aging resistance test in accordance with ISO 188 by placing the test piece in an oven and heating at 180° C. for 2,000 hours. After the 2,000 hours had elapsed, the multipurpose test piece (type A) was removed from the oven, and left to cool at 23° C. for 24 hours. Subsequently, the multipurpose test piece (type A) that had been subjected to the thermal aging resistance test was subjected to a tensile test in accordance with ISO 527 at a tensile speed of 5 mm/minute, thus measuring the tensile strength (Si) (MPa) following the thermal aging resistance test. The formula shown below was then used to calculate the tensile strength retention rate (%).

$$Tensile strength retention rate ( \% ) = S 1 / S 0 \times 100$$

### [Production of Flat Molded Articles]

Flat molded articles were produced in the following manner.

Using an injection molding device (NEX50III-5EG, manufactured by Nissei Plastic Industrial Co., Ltd.) with the cooling time set to 25 seconds, the screw rotation rate set to 200 rpm, the mold temperature set to 80° C., and the cylinder temperature set to 290° C., flat molded articles (6 cm×9 cm, thickness: 2 mm) were produced with the injection pressure and the injection speed adjusted appropriately so that the filling time fell within a range from 1.6±0.1 seconds.

### [Evaluation 2]

### (Tracking Resistance)

Using the flat molded article, a test was conducted in accordance with IEC 60112 using a tracking resistance test device (manufactured by Yamayo Shikenki Co., Ltd.), and the comparative tracking index (CTI) was calculated. A higher comparative tracking index (CTI) was deemed to indicate superior electrical characteristics.

### [Evaluation 3]

### (Volume Resistivity)

Using the flat molded article, the volume resistivity was measured in accordance with ASTM D257. A higher volume resistivity was deemed to indicate superior electrical characteristics.

### [Evaluation 4]

### (Surface External Appearance)

The 60-degree gloss of the central portion of the flat molded article was measured in accordance with JIS-K7150 using a gloss meter (IG320 manufactured by Horiba, Ltd.). A higher gloss value was deemed to indicate superior surface external appearance.

### [Evaluation 5]

### (Bleed Out Test)

In those cases where the polyamide composition contained the sterically hindered phenol (C) or the thermal stabilizer (C′) and the color of the molded article was black, bleed out of the sterically hindered phenol (C) or the thermal stabilizer (C′) was evaluated by visual inspection. In those cases where the polyamide composition contained the sterically hindered phenol (C) or the thermal stabilizer (C) and also contained the azine-based dye or phthalocyanine-based dye (D) or the carbon black (E), a bleed out test was conducted.

The flat molded article was left to stand for 500 hours in a constant-temperature constant-humidity chamber (temperature: 80° C., relative humidity: 95%). The flat molded article was then removed from the chamber, bleed out products on the surface of the molded article were inspected, and the susceptibility to bleed out was evaluated against the following criteria. In the tables, this evaluation is recorded as “bleed out suppression”.

### (Evaluation Criteria)

A: no bleed out products are visible on the flat molded article
B: bleed out products are visible on a portion of the flat molded article
C: bleed out products are visible across the entire flat molded article
D: large amounts of bleed out products are visible across the entire flat molded article

### [Evaluation 6]

### (Laser Marking Properties)

Using an MD-V9920 or MD-S9910 apparatus manufactured by Keyence Corporation, a 3 mm×3 mm square was printed onto the flat molded article by laser marking. The conditions for the laser marking included a wavelength of 1,064 nm and an output of 7.8 W. The laser marked portion was then inspected, and the laser marking properties were evaluated in the following manner.

### (Evaluation Criteria)

A: the laser marked portion appear white
D: the laser marked portion does not appear white

### [Evaluation 7]

### (Charpy Impact Strength)

Using the polyamide composition molded article (multipurpose test piece) obtained in each example and comparative example, the notched Charpy impact strength was measured in accordance with ISO 179.

### [Evaluation 8]

(Evaluation of Resistance to Elution of Additives into Water)

First, 30 g of the pellets of the polyamide composition and 30 g of distilled water were placed in a plastic bottle with a capacity of 100 mL, and the bottle was sealed and then left to stand in an electric oven at 80° C. for 24 hours. Following cooling, the water inside the plastic bottle was transferred to a beaker, and the pH at 23° C. was measured using a pH meter. Because the polyethyleneimine aqueous solution (B) is basic, a pH closer to 7 was deemed to indicate better resistance to elution of the polyethyleneimine (B) into the water. In the tables, the pH was recorded as “elution water pH”.

The physical property measurement methods and evaluation methods were conducted for each of the polyamide compositions. The results are shown in Table 1 to Table 4. The tensile strength values shown in the tables represent the initial tensile strength (S0) values (MPa).

TABLE 1

| | | | | Example | Example | Example | Example | Example | Example |
|---|---|---|---|---|---|---|---|---|---|
| | | | Units | 1 | 2 | 3 | 4 | 5 | 6 |
| Composition | Polyamide (A) | A-1 | % by mass | 64.09 | 58.09 | 64.34 | 63.09 | 63.54 | 64.09 |
| | | A-2 | % by mass | | | | | | |
| | | A-3 | % by mass | | 6 | | | | |
| | Polyethyleneimine | B-1 | % by mass | 0.5 | 0.5 | 0.25 | 1.5 | 0.5 | 0.5 |
| | (B) | B-2 | % by mass | | | | | | |
| | | B-3 | % by mass | | | | | | |
| | | B-4 | % by mass | | | | | | |
| | Sterically hindered | C-1 | % by mass | 0.25 | 0.25 | 0.25 | 0.25 | 0.8 | |
| | phenol (C) | C-2 | % by mass | | | | | | 0.25 |
| | Thermal stabilizer | C′-1 | % by mass | | | | | | |
| | (C′) | C′-2 | % by mass | | | | | | |
| | | C′-3 | % by mass | | | | | | |
| | | C′-4 | % by mass | | | | | | |
| | Azine-based dye or | D-1 | % by mass | 0.08 | 0.08 | 0.08 | 0.08 | 0.08 | 0.08 |
| | phthalocyanine-based | | | | | | | | |
| | dye (D) | D-2 | % by mass | | | | | | |
| | Carbon black (E) | E-1 | % by mass | 0.08 | 0.08 | 0.08 | 0.08 | 0.08 | 0.08 |
| | Filler (G) | G-1 | % by mass | 35 | 35 | 35 | 35 | 35 | 35 |

| | | | | | | | | |
|---|---|---|---|---|---|---|---|---|
| | Total | % by mass | 100 | 100 | 100 | 100 | 100 | 100 |
| | Halide ions (F) | ppm | 4 | 4 | 4 | 4 | 4 | 4 |
| Evaluations | Tensile strength | MPa | 181 | 175 | 185 | 172 | 181 | 180 |
| | Resistance to thermal aging | % | 61 | 63 | 55 | 65 | 62 | 56 |
| | Tracking resistance | V | 600 | 600 | 600 | 600 | 600 | 600 |
| | Volume resistivity | 10¹⁵ Ω · cm | 1.91 | 1.83 | 1.89 | 1.9 | 1.92 | 1.89 |
| | Surface external appearance | — | 48 | 65 | 40 | 55 | 38 | 48 |
| | Bleed out suppression | — | A | A | A | A | B | B |
| | Laser marking properties | — | A | A | A | A | A | A |
| | Charpy impact strength | kJ/m² | 9.5 | 9.3 | 10.4 | 8.1 | 9.3 | 9.3 |
| | Elution water pH | — | 9.3 | 9 | 8.6 | 10 | 9.1 | 9.3 |

TABLE 2

| | | | | Example | Example | Example | Example | Example | Example |
|---|---|---|---|---|---|---|---|---|---|
| | | | Units | 7 | 8 | 9 | 10 | 11 | 12 |
| Composition | Polyamide (A) | A-1 | % by mass | 64.09 | 64.09 | 64.15 | 63.97 | 64.09 | 63.47 |
| | | A-2 | % by mass | | | | | | |
| | | A-3 | % by mass | | | | | | |
| | Polyethyleneimine | B-1 | % by mass | | | 0.5 | 0.5 | 0.5 | |
| | (B) | B-2 | % by mass | 0.5 | | | | | 1 |
| | | B-3 | % by mass | | 0.5 | | | | |
| | | B-4 | % by mass | | | | | | |
| | Sterically hindered | C-1 | % by mass | 0.25 | 0.25 | 0.25 | 0.25 | 0.25 | 0.25 |
| | phenol (C) | C-2 | % by mass | | | | | | |
| | Thermal stabilizer | C′-1 | % by mass | | | | | | |
| | (C′) | C′-2 | % by mass | | | | | | |
| | | C′-3 | % by mass | | | | | | |
| | | C′-4 | % by mass | | | | | | |
| | Azine-based dye or | D-1 | % by mass | 0.08 | 0.08 | 0.02 | 0.2 | | |
| | phthalocyanine-based | | | | | | | | |
| | dye (D) | D-2 | % by mass | | | | | 0.08 | 0.2 |
| | Carbon black (E) | E-1 | % by mass | 0.08 | 0.08 | 0.08 | 0.08 | 0.08 | 0.08 |
| | Filler (G) | G-1 | % by mass | 35 | 35 | 35 | 35 | 35 | 35 |

| | | | | | | | | |
|---|---|---|---|---|---|---|---|---|
| | Total | % by mass | 100 | 100 | 100 | 100 | 100 | 100 |
| | Halide ions (F) | ppm | 34 | 4 | 2 | 10 | 15 | 100 |
| Evaluations | Tensile strength | MPa | 170 | 181 | 182 | 175 | 180 | 174 |
| | Resistance to thermal aging | % | 53 | 52 | 60 | 61 | 61 | 60 |
| | Tracking resistance | V | 600 | 600 | 600 | 600 | 600 | 600 |
| | Volume resistivity | 10¹⁵ Ω · cm | 1.41 | 1.9 | 1.92 | 1.89 | 1.2 | 1 |
| | Surface external appearance | — | 45 | 37 | 37 | 49 | 49 | 50 |
| | Bleed out suppression | — | B | A | A | A | A | A |
| | Laser marking properties | — | A | A | A | A | A | A |
| | Charpy impact strength | kJ/m² | 9.7 | 10.1 | 9.3 | 9.1 | 9.5 | 8.9 |
| | Elution water pH | — | 9.9 | 11 | 9.3 | 9.3 | 9.3 | 11 |

TABLE 3

| | | | | Example | Example | Example | Example | Example | Example |
|---|---|---|---|---|---|---|---|---|---|
| | | | Units | 13 | 14 | 15 | 16 | 17 | 18 |
| Composition | Polyamide (A) | A-1 | % by mass | 64.25 | 64.34 | 64.09 | 64.09 | 64.09 | 64.24 |
| | | A-2 | % by mass | | | | | | |
| | | A-3 | % by mass | | | | | | |
| | Polyethyleneimine | B-1 | % by mass | 0.5 | 0.5 | 0.5 | 0.5 | 0.5 | 0.5 |
| | (B) | B-2 | % by mass | | | | | | |
| | | B-3 | % by mass | | | | | | |
| | | B-4 | % by mass | | | | | | |
| | Sterically hindered | C-1 | % by mass | 0.25 | 0 | 0 | 0 | 0 | 0 |
| | phenol (C) | C-2 | % by mass | | | | | | |
| | Thermal stabilizer | C′-1 | % by mass | | | 0.25 | | | |
| | (C′) | C′-2 | % by mass | | | | 0.25 | | |
| | | C′-3 | % by mass | | | | | 0.25 | |
| | | C′-4 | % by mass | | | | | | 0.1 |
| | Azine-based dye or | D-1 | % by mass | 0 | 0.08 | 0.08 | 0.08 | 0.08 | 0.08 |
| | phthalocyanine-based | | | | | | | | |
| | dye (D) | D-2 | % by mass | | | | | | |
| | Carbon black (E) | E-1 | % by mass | 0 | 0.08 | 0.08 | 0.08 | 0.08 | 0.08 |
| | Filler (G) | G-1 | % by mass | 35 | 35 | 35 | 35 | 35 | 35 |

| | | | | | | | | |
|---|---|---|---|---|---|---|---|---|
| | Total | % by mass | 100 | 100 | 100 | 100 | 100 | 100 |
| | Halide ions (F) | ppm | 4 | 4 | 4 | 4 | 4 | 525 |
| Evaluations | Tensile strength | MPa | 205 | 181 | 183 | 180 | 181 | 182 |
| | Resistance to thermal aging | % | 61 | 49 | 48 | 60 | 61 | 65 |
| | Tracking resistance | V | 600 | 600 | 600 | 600 | 600 | 525 |
| | Volume resistivity | 10¹⁵ Ω · cm | 1.91 | 1.92 | 1.4 | 1.91 | 1.88 | 0.55 |
| | Surface external appearance | — | 58 | 49 | 48 | 47 | 48 | 48 |
| | Bleed out suppression | — | — | — | A | C | D | A |
| | Laser marking properties | — | D | A | A | A | A | A |
| | Charpy impact strength | kJ/m² | 12 | 9.6 | 9.5 | 9.5 | 9.2 | 9.5 |
| | Elution water pH | — | 9.3 | 9.3 | 9.7 | 9.5 | 9.5 | 9.7 |

TABLE 4

| | | | | Example | Example | Example | Example | Comparative |
|---|---|---|---|---|---|---|---|---|
| | | | Units | 19 | 20 | 21 | 22 | Example 1 |
| Composition | Polyamide (A) | A-1 | % by mass | | 64.17 | 64.17 | 64.09 | 64.59 |
| | | A-2 | % by mass | 64.34 | | | | |
| | | A-3 | % by mass | | | | | |
| | Polyethyleneimine | B-1 | % by mass | 0.5 | 0.5 | 0.5 | | 0 |
| | (B) | B-2 | % by mass | | | | | |
| | | B-3 | % by mass | | | | | |
| | | B-4 | % by mass | | | | 0.5 | |
| | Sterically hindered | C-1 | % by mass | 0 | 0.25 | 0.25 | 0.25 | 0.25 |
| | phenol (C) | C-2 | % by mass | | | | | |
| | Thermal stabilizer | C′-1 | % by mass | | | | | |
| | (C′) | C′-2 | % by mass | | | | | |
| | | C′-3 | % by mass | | | | | |
| | | C′-4 | % by mass | | | | | |
| | Azine-based dye or | D-1 | % by mass | 0.08 | 0 | 0.08 | 0.08 | 0.08 |
| | phthalocyanine-based | D-2 | % by mass | | | | | |
| | dye (D) | | | | | | | |
| | Carbon black (E) | E-1 | % by mass | 0.08 | 0.08 | 0 | 0.08 | 0.08 |
| | Filler (G) | G-1 | % by mass | 35 | 35 | 35 | 35 | 35 |

| | | | | | | | |
|---|---|---|---|---|---|---|---|
| | Total | % by mass | 100 | 100 | 100 | 100 | 100 |
| | Halide ions (F) | ppm | 525 | 2 | 4 | 34 | 4 |
| Evaluations | Tensile strength | MPa | 182 | 184 | 200 | 170 | 191 |
| | Resistance to thermal aging | % | 65 | 61 | 60 | 52 | 40 |
| | Tracking resistance | V | 525 | 600 | 600 | 600 | 600 |
| | Volume resistivity | 10¹⁵ Ω · cm | 0.55 | 1.93 | 1.9 | 1.4 | 2.15 |
| | Surface external appearance | — | 48 | 15 | 60 | 40 | 32 |
| | Bleed out suppression | — | A | D | A | B | A |
| | Laser marking properties | — | A | A | D | A | A |
| | Charpy impact strength | kJ/m² | 9.5 | 9.5 | 12 | 8 | 12 |
| | Elution water pH | — | 9.3 | 9.3 | 9.3 | 8.5 | 9 |

### INDUSTRIAL APPLICABILITY

By using the polyamide composition of an embodiment of the present invention, molded articles can be obtained which exhibit excellent mechanical properties, excellent resistance to thermal aging at 180° C. for long periods of about 2,000 hours and excellent electrical characteristics, suppress the bleed out of additives at 80° C. and a relative humidity of 95%, resist elution of the additives into water, and also have excellent external appearance. Molded articles obtained from the polyamide composition of an embodiment of the present invention can be used favorably as material components in a variety of applications, including vehicles, the machine industry, electrical and electronic applications, industrial materials, building materials, daily commodities, and household items.

1. A polyamide composition comprising:
a polyamide (A),
and also comprising, per 100 parts by mass of the polyamide (A):
at least 0.1 parts by mass but not more than 3 parts by mass of a branched polyamine (B),
at least 0.05 parts by mass but not more than 3 parts by mass of a sterically hindered phenol (C), and
at least 0.01 parts by mass but not more than 0.5 parts by mass of an azine-based dye or phthalocyanine-based dye (D), wherein
a concentration of halide ions (F) measured by combustion ion chromatography relative to a total mass of the polyamide composition is not more than 500 ppm by mass.

2. The polyamide composition according to claim 1, wherein the polyamide (A) comprises polyamide 66, and
an amount of polyamide 66 relative to a total mass of the polyamide (A) is at least 50% by mass.

3. The polyamide composition according to claim 1, wherein the branched polyamine (B) is a polyethyleneimine homopolymer or copolymer.

4. The polyamide composition according to claim 1, wherein a weight average molecular weight of the branched polyamine (B) is at least 400 but not more than 2,000.

5. The polyamide composition according to claim 1, wherein the sterically hindered phenol (C) contains at least one amide group.

6. The polyamide composition according to claim 1, further comprising at least 0.01 parts by mass but not more than 0.5 parts by mass of a carbon black (E) per 100 parts by mass of the polyamide (A).

7. The polyamide composition according to claim 1, wherein a concentration of halide ions (F) measured by combustion ion chromatography relative to a mass of the azine-based dye or phthalocyanine-based dye (D) is less than 1% by mass.

8. The polyamide composition according to claim 1, wherein a weight ratio between the branched polyamine (B) and the sterically hindered phenol (C) is within a range from 0.06 to 30, and a weight ratio between the sterically hindered phenol (C) and the azine-based dye or phthalocyanine-based dye (D) is within a range from 0.5 to 60.

9. The polyamide composition according to claim 1, further comprising a filler (G).

10. A polyamide composition comprising:
a polyamide (A), and
at least 0.1 parts by mass but not more than 3 parts by mass of a branched polyamine (B) per 100 parts by mass of the polyamide (A), wherein
a viscosity of the branched polyamine (B) at 20° C. measured using a Brookfield viscometer in accordance with ISO 2555 is at least 1,000 mPa·s but not more than 2,500 mPa·s.

11. The polyamide composition according to claim 10, wherein the polyamide (A) comprises polyamide 66, and an amount of polyamide 66 relative to a total mass of the polyamide (A) is at least 50% by mass.

12. The polyamide composition according to claim 10, wherein the branched polyamine (B) is a polyethyleneimine homopolymer or copolymer.

13. The polyamide composition according to claim 10, wherein a weight average molecular weight of the branched polyamine (B) is at least 400 but not more than 2,000.

14. The polyamide composition according to claim 10, further comprising at least 0.05 parts by mass but not more than 3 parts by mass of an organic thermal stabilizer (C) per 100 parts by mass of the polyamide (A).

15. The polyamide composition according to claim 14, wherein the organic thermal stabilizer (C) is a sterically hindered phenol (C1).

16. The polyamide composition according to claim 15, wherein the sterically hindered phenol (C1) contains at least one amide group.

17. The polyamide composition according to claim 10, further comprising an azine-based dye or phthalocyanine-based dye (D).

18. The polyamide composition according to claim 17, wherein a concentration of halide ions (F) measured by combustion ion chromatography relative to a mass of the azine-based dye or phthalocyanine-based dye (D) is less than 1% by mass.

19. The polyamide composition according to claim 10, further comprising at least 0.001 parts by mass but not more than 0.5 parts by mass of a carbon black (E) per 100 parts by mass of the polyamide (A).

20. The polyamide composition according to claim 10, wherein a concentration of halide ions (F) measured by combustion ion chromatography relative to a total mass of the polyamide composition is not more than 500 ppm by mass.

21. (canceled)
